(19) United States
(12) Patent Application Publication
(10) Pub. No.: US 2008/0132604 A1
(43) Pub. Date: Jun. 5, 2008

(54) Poly-(alpha-hydroxy acid) composition and method of producing molded article using the same

(75) Inventors: Teruyuki Yatabe, Kanagawa (JP); Atsushi Matsumoto, Kanagawa (JP); Masanobu Yamamoto, Shizuoka (JP)

Correspondence Address: BUCHANAN, INGERSOLL & ROONEY PC, POST OFFICE BOX 1404, ALEXANDRIA, VA, 22313-1404, US

(73) Assignee: TERUMO KABUSHIKI KAISHA, Tokyo (JP)

(21) Appl. No.: 11/998,424

(22) Filed: Nov. 30, 2007

Related U.S. Application Data
(60) Provisional application No. 60/960,752, filed on Oct. 12, 2007.

(30) Foreign Application Priority Data
Nov. 30, 2006 (JP) 2006-324571

(51) Int. Cl. B29C 45/73; C08L 61/00

(52) U.S. Cl. 523/121; 264/328.16

(57) ABSTRACT

A poly-(α-hydroxy acid) composition including a poly-(α-hydroxy acid), and an amino acid, and a method of producing a molded article using the poly-(α-hydroxy acid) composition.

### CROSS-REFERENCE TO RELATED APPLICATION

This application claims the benefit of priority of U.S. Provisional Application No. 60/960,752 filed Oct. 12, 2007, the contents of which are herein incorporated by reference.

### TECHNICAL FIELD

This application generally relates to a poly-(α-hydroxy acid) composition, particularly to a poly-(α-hydroxy acid) composition which contains a poly-(α-hydroxy acid) and an amino acid and which can be used as a device suitable to be embedded in vivo, especially embedded in a blood vessel.

### BACKGROUND

A poly-(α-hydroxy acid) such as poly(p-dioxanone) and polylactic acid are thermoplastic polyesters which can be hydrolyzed with the ambient moisture even under mild conditions such as body temperature and room temperature. Since the α-hydroxy acids produced upon the hydrolysis of poly-(α-hydroxy acid) are metabolized by microorganisms or in vivo or are discharged to the exterior of the living body without exhibiting any excess of toxicity, investigations have been made into the application of poly-(α-hydroxy acid) to such uses as to be intended to disappear by being absorbed by microorganisms in soil after disposal thereof or application to devices which will disappear after being embedded in vivo as a medical device.

Poly-(α-hydroxy acid) is known to have a low crystallization rate. The low crystallization rate constitutes a serious disadvantage in producing a product by a method in which a molten resin is injected into a mold of a specified shape and is solidified by cooling to obtain a molded article, i.e., the so-called injection molding method. In a general injection molding machine, a series of operations of melting a resin in a cylinder, injecting a predetermined amount of the molten resin into a mold being cooled to solidify and mold the resin, opening the mold to demold the molded article, then closing the mold, and again injecting the molten resin from the cylinder into the mold, are repeated to obtain a large number of molded articles. As this cycle is conducted fast, the time required for the operations ranging from the melting of the resin in the cylinder to the injection of the molten resin into the mold and the solidification of the resin is shorter, so that pyrolysis of the resin can be prevented, and a larger number of molded articles can be obtained in a shorter time, which leads to a reduction in production cost. Since the time required for injection of the molten resin and the time required for removal of the molded article from the mold are each at most about 10 seconds, the cooling time which is on the order of several minutes is the factor which is the most heavily relating to stabilization of the molecular weight of the molded article and to productivity of the molded article.

For example, in the case of polylactic acid, even if the polymer is cooled to a preferable crystallization temperature, a half crystallization time of not less than 5 minutes is needed (S. Iannace and L. Nicolais, Journal of Applied Polymer Science, 1997, vol. 64, p. 911).

U.S. Pat. No. 5,611,986 discloses that a cooling time in injection molding of poly(p-dioxanone) is 75 to 120 seconds, and a preferable cooling time is 90 to 105 seconds. In the case of poly(p-dioxanone), which has a glass transition temperature of about −20° C., when the crystallization of the polymer has not yet progressed even though the polymer could be cooled in the mold to the vicinity of room temperature, the polymer is in a rubbery state of being readily deformable, so that the resin is susceptible to deformation at the time of demolding and, in some cases, the molded article cannot be demolded. In addition, during the time of extrusion molding, the molded article is susceptible to sticking until the crystallization thereof progresses, leading to difficulties in management.

As a method for shortening the time required for cooling and solidification of poly(p-dioxanone), there is a method in which poly(p-dioxanone) is molded in the condition where self crystal nuclei are remaining, by not completely melting poly(p-dioxanone) at the time of melting it in the cylinder. According to Macromolecular Chemistry and Physics, 2000, 201, p. 2687 (M. A. Sabino et al.), such formation of self crystal nuclei is confirmed in the temperature range of from the melting point of poly(p-dioxanone) to 116° C.; also, U.S. Pat. No. 5,611,986 describing the injection molding of poly(p-dioxanone) discloses a preferable melting temperature of 105 to 115° C. Even under these conditions, however, a cooling time of not less than 90 seconds is needed, as disclosed in U.S. Pat. No. 5,611,986.

In the case of polylactic acid, it is possible, by utilizing its comparatively high glass transition temperature (Tg) of about 60° C., to set the conditions for rapidly cooling the resin to the vicinity of room temperature and removing the molded article from the mold. However, for stabilization of the shape during preservation of the molded article of polylactic acid, the molded article is preferably annealed at a high temperature after being demolded. As a result of the annealing, the molded article is susceptible to shrinkage or deformation. Therefore, the molded articles of polylactic acid which can be produced are limited to those of which the shape may be instable.

Moreover, when the cooling time is long, the resin in the molten state would dwell in the cylinder for a long time. Since the poly-(α-hydroxy acid) is liable to decomposition under heating with the result of a lowering in molecular weight, there would be dispersion of molecular weight among the molded articles thus obtained. As a result, the decomposition speed, which is one of the characteristic features of the poly-(α-hydroxy acid), may vary from molded article to molded article. This imposes a serious problem especially on stable production of a medical device intended to disappear after a predetermined period of time by hydrolysis in a living body.

In order to solve the above-mentioned problems, in general, a crystal nucleus agent such as dibenzalsorbitol and talc is added to the resin.

However, such crystal nucleus agent is decomposed in vivo with difficulty. Therefore, where the crystal nucleus agent is contained in an implant device produced so as to be decomposed and absorbed in vivo, the crystal nucleus agent being insusceptible to absorption into the living body may cause chronic inflammation or foreign body carcinogenesis. Also, the quaternary ammonium compound is a compound which is not intrinsically present in the living body, so that it may adversely affect the living body through a tissue reaction.

### SUMMARY

According to one aspect, there is provided a poly-(α-hydroxy acid) composition including: a poly-(α-hydroxy acid); and an amino acid.

Another aspect involves a method of producing a molded article, including the stages of: mixing a poly-(α-hydroxy acid) with an amino acid to prepare a poly-(α-hydroxy acid) composition; and molding the poly-(α-hydroxy acid) composition.

An additional aspect is directed to a molded article formed from the poly-(α-hydroxy acid) composition.

A further aspect is directed to a blood vessel wall closing device comprising the molded article.

In accordance with exemplary aspects, a poly-(α-hydroxy acid) composition which is safely absorbed and/or metabolized in vivo can be provided.

### BRIEF DESCRIPTION OF THE DRAWINGS

FIG. 1 is a flow chart showing exemplary steps for injection molding a poly-(α-hydroxy acid) composition;

FIG. 2 is a schematic view showing an example of an injection molding machine used in the step of molding an α-hydroxy acid;

FIG. 3 is a sectional view showing an in vivo tissue closing device;

FIG. 4 is a perspective view of an in vivo tissue closure in the in vivo tissue closing device shown in FIG. 3;

FIG. 5 is a graph showing the relationship between the content of an amino acid in a poly-(α-hydroxy acid) composition according to one aspect and half crystallization time of the composition; and

FIG. 6 is a sectional view of a molded article, for evaluating the moldability of the poly-(α-hydroxy acid) composition.

### DETAILED DESCRIPTION

An embodiment resides in a poly-(α-hydroxy acid) composition containing a poly-(α-hydroxy acid) and an amino acid. The poly-(α-hydroxy acid) composition of this embodiment contains no ingredient that is hard to metabolize safely in vivo or that is toxicic. In addition, the amount of the amino acid added to the composition is on such a level as not to influence the performance of the poly-(α-hydroxy acid) itself, i.e., a level of not more than several percent, which level is comparable to the ordinary level of amount of a nucleus agent, so that the crystallization rate having hitherto been a large problem as to the poly-(α-hydroxy acid) is greatly improved.

The poly-(α-hydroxy acid) in the embodiment includes a homopolymer, a random copolymer, a block copolymer, or a mixture thereof, of an α-hydroxy acid, which may be used either singly or in combination of two or more of them. Specifically, the poly-(α-hydroxy acid) is a crystalline polymer including a chemical structural portion represented by the following formula (1).

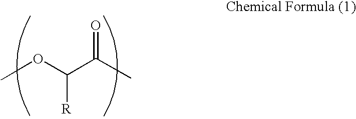

In the chemical formula (1), R is a hydrogen atom or a straight chain or branched alkyl group having 1 to 3 carbon atoms.

Specific preferable examples of the poly-(α-hydroxy acid) including the chemical structural portion represented by the chemical formula (1) include polylactic acid, polyglycolic acid, poly(p-dioxanone), and copolymers thereof. These materials are selected according to the required performances of the device desired. For example, for devices required to have flexibility and elasticity, such as tissue clips and the blood vessel wall closing devices to be described later, poly(p-dioxanone) can be used. On the other hand, for devices required to have high strength such as stents and sutures, polylactic acid or polyglycolic acid can be used. Where it is necessary to maintain strength for a comparatively long time after embedding of the device in vivo, polylactic acid can be used.

Means of acquisition of the poly-(α-hydroxy acid) is not particularly limited. Where a commercial product of poly-(α-hydroxy acid) is available, the commercial product may be purchased and used; also, an poly-(α-hydroxy acid) prepared by the user using a conventionally known method such as ring opening polymerization may be used.

The molecular weight of the poly-(α-hydroxy acid) is not particularly limited, insofar as the molecular weight is on such a level as to make it possible for the molded article of the polymer to maintain its functions. For example, in the case of poly(p-dioxanone), its inherent viscosity is preferably 0.5 to 5.0 dL/g, more preferably 1.0 to 4.0 dL/g. The inherent viscosity herein means a viscosity as measured for a solution of 20 mg of a poly-(α-hydroxy acid) in 20 mL of hexafluoroisopropanol (HFIP) at 25° C., by use of a Type 1 Ubbelohde's viscometer described in JIS K 7367-1.

The amino acid used in the present invention is not particularly limited, insofar as the amino acid is decomposed and/or metabolized in vivo. Examples of the amino acid which can be used include aliphatic amino acids such as glycine, D-alanine, L-alanine, D-valine, L-valine, D-leucine, L-leucine, D-isoleucine, L-isoleucine, D-alloisoleucine, L-alloisoleucine, D-serine, L-serine, D-threonine, L-threonine, D-allothreonine, L-allothreonine, D-aspartic acid, L-aspartic acid, D-asparagine, L-asparagine, D-glutamic acid, L-glutamic acid, D-glutamine, L-glutamine, D-lysine, L-lysine, D-δ-hydroxylysine, L-δ-hydroxylysine, D-arginine, L-arginine, D-cystene, L-cystene, D-cystine, L-cystine, D-methionine, L-methionine, D-aminobutyric acid, L-aminobutyric acid, D-omithine, L-omithine, D-citrulline, L-citrulline, etc.; aromatic amino acids such as D-phenylalanine, L-phenylalanine, D-tyrosine, L-tyrosine, D-3,5-dibromotyrosine, L-3,5-dibromotyrosine, D-3,5-diiodotyrosine, L-3,5-diiodotyrosine, D-3,5,3′-triiodotyrosine, L-3,5,3′-triiodotyrosine, D-thyroxine, L-thyroxine, etc.; and heterocyclic amino acids such as D-proline, L-proline, D-hydroxyproline, L-hydroxyproline, D-tryptophan, L-tryptophan, D-histidine, L-histidine, etc. Those amino acids can be used either alone or in the form of mixture of at least two kinds. Among these amino acids, preferred are L-amino acids such as glycine, L-alanine, L-valine, L-leucine, L-isoleucine, L-alloisoleucine, L-serine, L-threonine, L-allothreonine, L-aspartic acid, L-asparagine, L-glutamic acid, L-glutamine, L-lysine, L-δ-hydroxylysine, L-arginine, L-cysteine, L-cystine, L-methionine, L-aminobutyric acid, L-ornithine, L-citrulline, L-phenylalanine, L-tyrosine, L-3,5-dibromotyrosine, L-3,5-diiodotyrosine, L-3,5,3′-triiodotyrosine, L-thyroxine, L-proline, L-hydroxyproline, L-tryptophan, L-histidine, etc., and more preferred is L-tyrosine, from the viewpoints of safety to organisms and load on environments.

Tyrosine includes three structural isomers of o-tyrosine, m-tyrosine and p-tyrosine, depending on the position of the hydroxyl group. Tyrosine is produced in vivo by an enzyme reaction of phenylalanine, which is an ordinary metabolizing reaction; in this case, only p-tyrosine is produced. p-Tyrosine has been confirmed to be safe to organisms, is described in Japanese Standards of medical and pharmaceutical products falling outside the Japanese Pharmacopoeia and the official prescription of food additives, and is widely used as a pharmaceutical product and as a food additive. In addition, p-tyrosine is used as a culture medium for culture of microorganisms, and is known to be easily decomposed by microorganisms and to impose a low load on environments after disposal thereof.

On the other hand, o-tyrosine and m-tyrosine are known to be produced in vivo in the case where oxidative stress is higher than usual, due to the presence of active oxygen or the like, and they are not used generally as pharmaceutical products or the like. Taking into account the safety to organisms and environments, therefore, it is most preferable to use p-tyrosine.

Besides, p-tyrosine is industrially produced in large amounts. From the viewpoint of lowering in production cost, also, it is most preferable to use p-tyrosine, among the three kinds of structural isomers.

The content of the amino acid in the poly-(α-hydroxy acid) composition according to the present invention may be appropriately determined according to the kind of the poly-(α-hydroxy acid) and the kind of the amino acid, and is preferably 0.01 to 10% by weight, more preferably 0.01 to 5.0% by weight, and further preferably 0.01 to 2.0% by weight, per 100% by weight of the total amount of the poly-(α-hydroxy acid) composition. If the content of the amino acid is less than 0.01% by weight, it may be impossible to obtain the increasing effect on the crystallization rate of the poly-(α-hydroxy acid). On the other hand, if the content of the amino acid exceeds 10% by weight, physical properties such as strength and elastic modulus of the poly-(α-hydroxy acid) composition may be lowered.

Where the amino acid is tyrosine, the content thereof is preferably 0.01 to 2% by weight, more preferably 0.01 to 1.5% by weight, and further preferably 0.01 to 1.0% by weight, per 100% by weight of the total amount of the poly-(α-hydroxy acid) composition. If the tyrosine content is less than 0.01% by weight, it may be impossible to obtain the increasing effect on the crystallization rate of the poly-(α-hydroxy acid). On the other hand, if the tyrosine content exceeds 2% by weight, the increasing effect on the crystallization rate of the poly-(α-hydroxy acid) may differ little from that in the case where the content is within the above-mentioned range.

Where an acidic amino acid or a basic amino acid is used as the amino acid, it is preferable to preliminarily neutralize the electric charges of the amino acid by mixing the acidic amino acid with a basic compound or mixing the basic amino acid with an acidic compound. When the electric charges of the amino acid are not neutralized, the amino acid may act as an acid or base to accelerate the decomposition of the poly-(α-hydroxy acid), resulting in that the desired decomposition rate of the poly-(α-hydroxy acid) cannot be obtained.

Preferable examples of the basic compound which can be mixed with the acidic amino acid include sodium hydroxide, potassium hydroxide and magnesium hydroxide.

Preferable examples of the acidic compound which can be mixed with the basic amino acid include phosphoric acid, sulfuric acid and hydrochloric acid.

The amount of the acidic compound or basic compound to be mixed with the amino acid is determined by the valence of the acidic amino acid or basic amino acid. The term “valence” used here means the difference between the number of amino and imino groups in the molecule of the amino acid and the number of carboxyl groups in the molecule. For example, in the case of using aspartic acid, which is an acidic acid, aspartic acid is deemed as a monovalent acid because it has two carboxyl groups and one amino group in its molecule, and a base may be mixed therewith in such an amount as to neutralize the monovalent acid. In the case of using lysine, which is a basic amino group, lysine is deemed as a monovalent base because it has one carboxyl group and two amino groups in its molecule, and an acid may be mixed therewith in such an amount as to neutralize the monovalent base.

The method for mixing the acidic acid with the basic compound and the method for mixing the basic amino acid with the acidic compound are not particularly limited. For example, use may be made of a method in which the acidic amino acid is mixed with the basic compound, or the basic amino acid is mixed with the acidic compound, in a solvent such as water and alcohol.

The poly-(α-hydroxy acid) composition according to the present invention may be admixed with a coloring matter as a third ingredient so that the composition is colored. Examples of the coloring matter which can be used in the present invention include D&C Violet No. 2. The amount in which the coloring matter can be added is preferably 100 to 3,000 ppm, more preferably 500 to 2,000 ppm, based on the mass of the poly-(α-hydroxy acid). Addition of the coloring matter makes it possible to obtain a colored poly-(α-hydroxy acid) composition with good moldability, without producing any special problem.

### <Method of Producing Molded Article>

Now, a method of producing a molded article of this embodiment will be described below.

The method of producing a molded article includes a step of mixing a poly-(α-hydroxy acid) with an amino acid to prepare a poly-(α-hydroxy acid) composition (poly-(α-hydroxy acid) composition preparing step), and a step of molding the thus obtained poly-(α-hydroxy acid) composition to obtain the molded article (molding step).

Now, the producing method as above will be described in detail in the sequence of steps, but the method is not limited to the following configuration.

### <Poly-(α-hydroxy Acid) Composition Preparing Step>

In this step, a poly-(α-hydroxy acid) and an amino acid are mixed with each other to prepare a poly-(α-hydroxy acid) composition.

The method of mixing is not particularly mixed, and a general polymer blending method may be adopted. For example, a method of melting and kneading a poly-(α-hydroxy acid) and an amino acid by use of an extruder or a Banbury mixer may be adopted, in which the amino acid is mixedly dispersed or dissolved in a solution obtained by dissolving the poly-(α-hydroxy acid) in a solvent such as hexafluoroisopropanol (HFIP), chloroform, methylene chloride and benzene in a concentration of preferably 0.1 to 30% by weight, and thereafter the solvent is evaporated off.

In the case of preparing the poly-(α-hydroxy acid) composition by melt kneading of a poly-(α-hydroxy acid) and an amino acid, the amino acid to be used is preferably a fine powder. The amino acid plays the role of a crystal nucleus agent for the poly-(α-hydroxy acid). Since the crystal nucleus agent provides starting points of crystallization in curing of the crystalline resin, it is preferable for the amino acid to be dispersed more favorably in the resin, so that the amino acid is preferably in the state of a finer powder. Specifically, the particle diameter of the amino acid in terms of number average diameter is 0.04 to 10 μm, more preferably 0.04 to 1 μm. In addition, the poly-(α-hydroxy acid) is preferably like cylindrical or other-shaped pellets, crushed pellets or pulverized product in shape. Further, the particle diameter of the poly-(α-hydroxy acid) is preferably 1 to 5 mm. Incidentally, the particle diameter of the amino acid is a particle diameter value measured for a dispersion of the amino acid in 2-propanol used as a dispersion medium by use of a laser diffraction scattering particle size distribution measuring system LS230 (produced by Beckman Coulter, Inc.).

The method of preparing a fine powder of the amino acid is not particularly limited, and any of conventionally known methods may be used. Examples of the method of preparing a fine powder of the amino acid include a method in which a diluted solution obtained by dissolving the amino acid in hot water or the like is rapidly frozen and subjected to freeze drying or is dried by a spray dryer, a method in which a solution obtained by dissolving the amino acid in an acid or alkali solution is rapidly neutralized, and a method in which the amino acid is mechanically crushed (ground) by a ball mill or the like.

A classifying method for obtaining an amino acid with a particle diameter in the above-mentioned range is not particularly limited, and any of conventionally known methods may be used. Examples of the classifying method include a method of classifying by use of a sieve, a method of classifying by utilization of differences in dropping velocity or dropping position among particles, a method of classifying by utilization of inertial forces in a gas stream, and a method of classifying by screening with a liquid used as a fluid.

The temperature, the kneading time and the like in the melt kneading may be set variously according to the melting point, viscosity, and heat resistance of the poly-(α-hydroxy acid) used, the heat resistance of the amino acid, the physical properties required of the final product, and the processing methods used for obtaining the final product. In general, since the poly-(α-hydroxy acid) is susceptible to pyrolysis, the poly-(α-hydroxy acid) may be kneaded at a temperature of higher than the melting point of the poly-(α-hydroxy acid) by about 20° C. by use of a Banbury mixer or a twin-shaft kneader-extruder, whereby the poly-(α-hydroxy acid) composition of the embodiment can be prepared. Specifically, the melt kneading temperature is preferably in the range of from the melting point of the poly-(α-hydroxy acid) to a temperature of higher than the melting point by 40° C., more preferably in the range of from the melting point of the poly-(α-hydroxy acid) to a temperature of higher than the melting point by 20° C. For example, in the case of poly(p-dioxanone), which has a melting point of 106° C., a fine powder of L-p-tyrosine with a particle diameter of 0.1 μm prepared by freeze drying as above-mentioned and crushed pellets of poly(p-dioxanone) are dry blended at room temperature and then kneaded while melting at 120° C., by use of a 250-mL Banbury mixer, whereby a substantially homogeneous poly-(α-hydroxy acid) composition can be obtained in about 15 min.

As the amino acid, an amino acid which is not decomposed or denatured at the melting temperature of the poly-(α-hydroxy acid) may be appropriately selected and used. Decomposition temperatures of amino acids are generally not less than 200° C. In the poly-(α-hydroxy acid) composition, the decomposition temperature of tyrosine serving as a preferable amino acid is 344° C., so that tyrosine can be used as a crystal nucleus agent for polyglycolic acid (melting point: 218° C.) and a stereo complex (melting point: 228° C.) of poly-D-lactic acid and poly-L-lactic acid, which are high in melting point among the poly-(α-hydroxy acids).

Besides, at this stage, a coloring agent as a third ingredient may be added to the poly-(α-hydroxy acid) composition, thereby coloring the composition. For example, in the case of poly(p-dioxanone), D&C Violet No. 2 can be added in an amount of preferably 100 to 3,000 ppm, more preferably 500 to 2,000 ppm based on the total mass of the poly-(α-hydroxy acid) and the amino acid. Even in this case, it is possible to obtain a colored poly-(α-hydroxy acid) composition with good moldability, without producing any special problem.

### <Poly-(α-hydroxy Acid) Composition Molding Step>

In this step, the poly-(α-hydroxy acid) composition is molded, to produce a molded article.

The molding method is not particularly limited. For example, any of conventionally known methods such as extrusion molding, injection molding, blow molding, compression molding, and thermoforming can be adopted. Among these molding methods, preferred is injection molding. Now, an injection molding method as a preferred embodiment of the present invention will be described below.

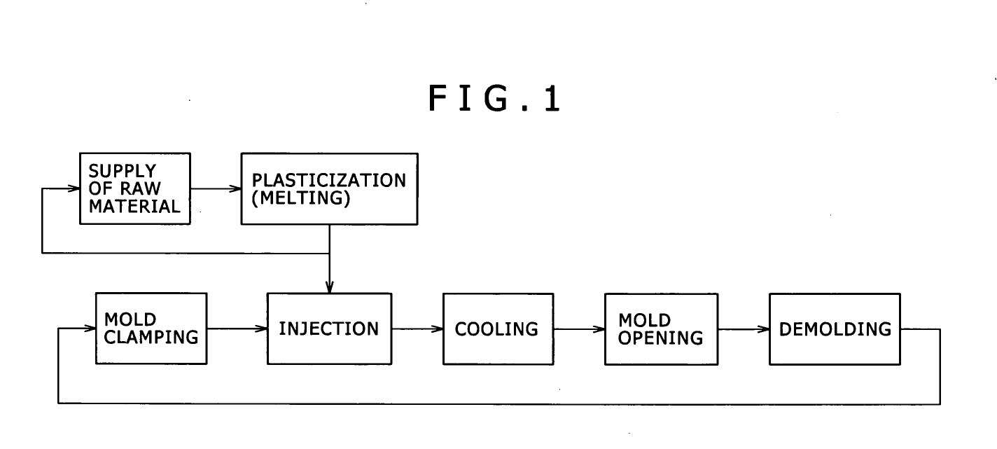

In the injection molding method, as shown in FIG. 1, an injection molding machine is supplied with a raw material resin, which is then melted, and the cycle of (1) mold clamping, (2) injection of the molten resin, (3) cooling, (4) mold opening, and (5) demolding is repeated, to produce a large number of products.

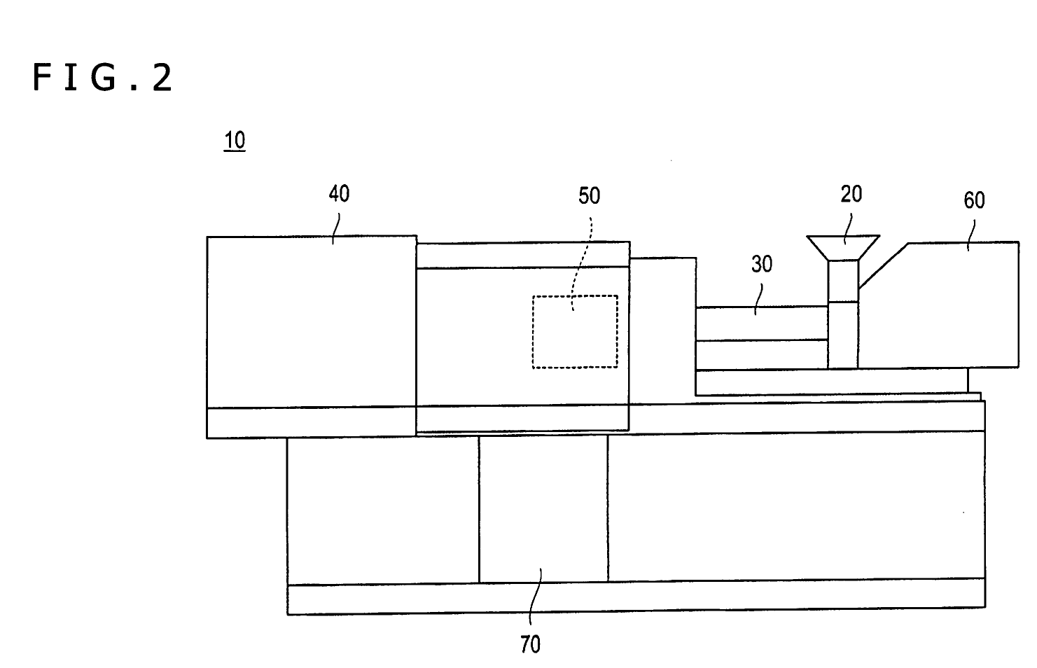

FIG. 2 is a schematic view showing an example of the injection molding machine 10 used in this step.

Referring to FIG. 2, the poly-(α-hydroxy acid) composition of the embodiment as a raw material is fed through a raw material supplying device 20, and is melted in a cylinder 30. A mold 50 is clamped by a mold clamping device 40. The poly-(α-hydroxy acid) composition melted is injected into the mold 50 by a screw advancing from an injection power unit 60. The poly-(α-hydroxy acid) composition is cooled in the mold 50, then the mold 50 is opened, and the molded article is removed therefrom through a molded article demolding section 70. After the demolding of the product, the mold 50 is closed, the molten resin is injected again from the cylinder 30 into the mold 50, and this series of operations is repeated, to obtain a large number of molded articles.

Among the molding conditions in the injection molding method, important are injection molding machine cylinder temperature, injection molding machine mold temperature, and cooling time for the resin injected into the mold.

For example, in the case of performing injection molding by use of a 20 t injection molding machine NS20 produced by Nissei Plastic Industrial Co., Ltd., molding can be conducted at a mold temperature of 45° C., a cylinder temperature of 120° C., and a cooling time of 7 to 8 seconds. Where the mold temperature is 45° C. and the cylinder temperature is 140° C., molding can be performed with a cooling time of preferably 10 to 20 seconds; where the cylinder temperature is 160° C., molding can be performed with a cooling time of preferably about 40 seconds. In short, with a cylinder temperature in the range of 106 to 160° C., the cooling time can be shortened to preferably 1 minute or below, and the molding cycle time can thus be shortened.

In the molded article obtained using the poly-(α-hydroxy acid) composition, in the case of producing a molded article of which deformation during use is to be suppressed, the molding can be conducted by lowering the cylinder temperature to such a level that the melting is insufficient and self crystal nuclei are remaining, i.e., to such a temperature which is close to the melting point and at which the resin flow necessary for injection molding can be secured, regardless of some brittleness of the molded article and dispersion of shape due to defective resin flow. In such a case, the preferable molding conditions are a cylinder temperature of 106 to 120° C., a mold temperature of 40 to 50° C., and a cooling time of 5 to 20 seconds.

On the other hand, in the case of producing a molded article required of large deformation such as, for example, a spring, it is preferable to inject a uniformly molten resin. In such a case, the preferable molding conditions are a cylinder temperature of 120 to 140° C., a mold temperature of 40 to 50° C., and a cooling time of 5 to 40 seconds, for example, 10 to 40 seconds. Since the amino acid added functions as a crystal nucleus agent, the poly-(α-hydroxy acid) composition can be molded stably, without relying on the instable self crystal nuclei formed depending on the cylinder temperature and the time after melting.

In addition, the cooling time can be more shortened by increasing the content of the amino acid in the poly-(α-hydroxy acid) composition. As the content of the crystal nucleus agent is larger, the crystal grains of polymer in the composition become smaller and the brittleness of the composition can be improved more. This means that by varying the content of the amino acid, it is possible to widen the preferable temperature ranges and to further shorten the cooling time. However, it is preferable to render the amount of the crystal nucleus agent as small as possible. Therefore, the well-balanced preferable molding conditions are an injection molding machine cylinder temperature of 106 to 140° C., an injection molding machine mold temperature of 40 to 50° C., and a cooling time in the mold of the injection molding machine of 5 to 40 seconds.

The poly-(α-hydroxy acid) composition is high in safety to organisms and is absorbed into organisms in a predetermined period of time. Therefore, the poly-(α-hydroxy acid) composition can be suitably used as an in vivo embedded type device such as suture, anti-adhesion agent, prosthetic material, mesh, patch, clip, stable, etc., and can particularly be used as a device to be embedded in a blood vessel, which device is most required to have high safety. Specifically, the poly-(α-hydroxy acid) composition according to the present invention can be suitably used as a blood vessel wall closing device for closing a punctured hole formed in an artery by introduction of a catheter, for example, the device described in U.S. Patent Application Publication No. 2006/135991 A1.

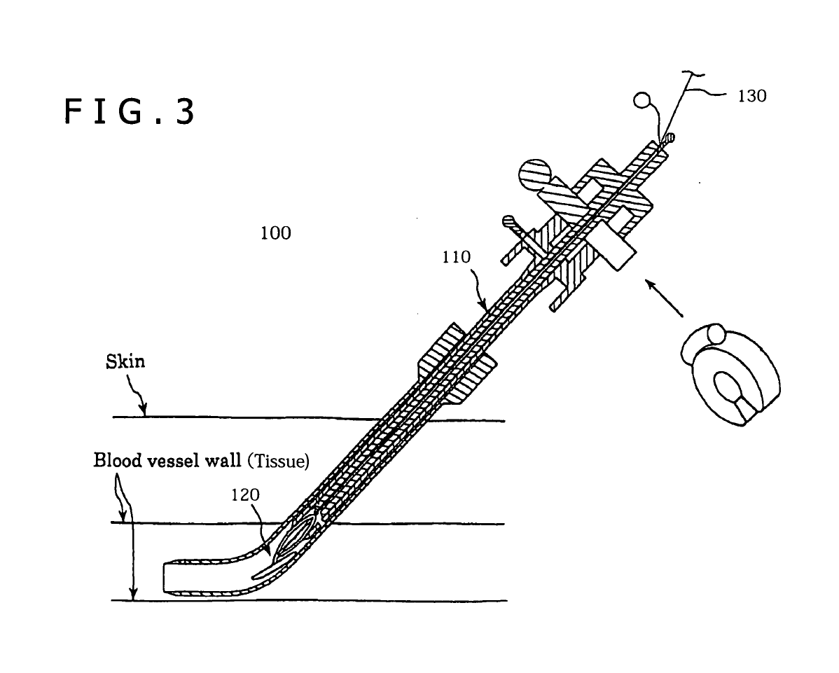

FIG. 3 is a sectional view showing an in vivo tissue closing device 100 comprising the above-mentioned blood vessel wall closing device. The in vivo tissue closing device 100 is a device for closing a wound hole which is formed in an in vivo tissue membrane such as an in vivo lumen, an in vivo organ, an in vivo tissue, etc. and which penetrates percutaneously (a wound hole penetrating an in vivo tissue membrane). As shown in FIG. 3, the in vivo tissue closing device 100 includes a long main body section 110, a clip 120 as an in vivo tissue closure which is detachably attached to (held by) a distal portion of the main body section 110 and which closes a wound penetrating an in vivo tissue membrane, and a thread 130 as a pulling means for pulling the clip 120.

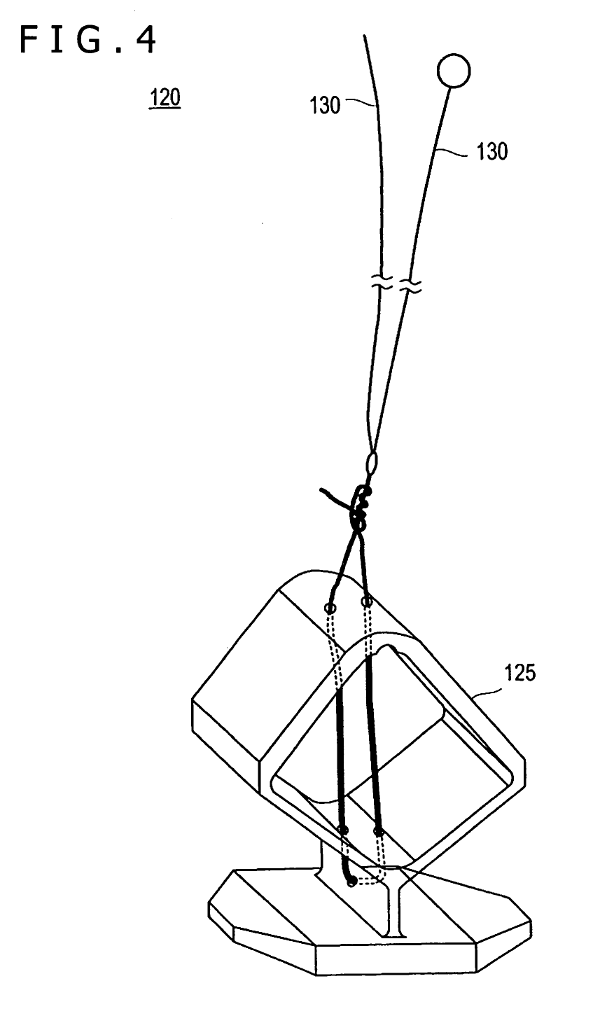

FIG. 4 is a perspective view of the clip 120, and the poly-(α-hydroxy acid) composition is suitably used as a material for forming the clip 120.

### EXAMPLES

Now, the present invention will be described more in detail below referring to Examples, but the Examples do not limit the present invention in any way.

### Preparation Examples 1 to 7

### <Preparation of Fine Powder of Amino Acid>

Aqueous 0.1% by weight amino acid solutions were prepared by use of the amino acids as set forth in Table 1 below. Each of the aqueous solutions was dropped into liquid nitrogen to effect rapid freezing, followed by freeze drying, to obtain fine powders of amino acids with particle diameters as shown in Table 1 below. It is to be noted here that in the cases of L-p-tyrosine and L-phenylalanine which are difficultly soluble in water, the amino acid was dissolved in boiling water, followed by the same treatment as above, to obtain the fine powder. The particle diameter of each of the amino acids thus obtained was measured with 2-propanol by use of a laser diffraction scattering particle size distribution measuring system LS230 (produced by Beckman Coulter, Inc.).

TABLE 1

| | Kind of Amino Acid | Particle Diameter (μm) |
|---|---|---|
| Preparation Example 1 | L-p-tyrosine | 0.1 |
| Preparation Example 2 | L-leucine | 0.1 |
| Preparation Example 3 | Glycine | 0.1 |
| Preparation Example 4 | L-serine | 0.1 |
| Preparation Example 5 | L-asparagine | 0.1 |
| Preparation Example 6 | L-phenylalanine | 0.1 |
| Preparation Example 7 | L-proline | 0.1 |

### <Influence of Amino Acid Addition on Crystallization Rate>

Crushed pellets (inherent viscosity: 2.4 dL/g) of poly(p-dioxanone) containing 1000 ppm of D&C Violet No. 2 as a coloring matter and crushed pellets (inherent viscosity: 2.3 dL/g) of poly(p-dioxanone) not containing any coloring matter were respectively dissolved in hexafluoroisopropanol, to prepare solutions having a polymer concentration of 5 g/dL. In addition, crushed pellets (inherent viscosity: 1.9 dL/g) of poly-L-lactic acid were dissolved in chloroform, to prepare a solution having a polymer concentration of 5 g/dL. Each of the amino acid fine powders prepared in Preparation Examples 1 to 7 was added to the poly(p-dioxanone) solution containing the coloring matter and to the poly-L-lactic acid solution in an amount of 1% by weight based on the polymer. To the poly(p-dioxanone) solution not containing any coloring matter, the L-p-tyrosine fine powder prepared in Preparation Example 1 was added in an amount of 1% by weight based on the polymer. Ultrasonic waves are applied to each of the thus obtained compositions to effect dispersion, and the dispersed composition was cast on a glass, followed by volatilization of the solvent. Thereafter, using a vacuum dryer, each of the cast compositions was dried for three hours at normal temperature while reducing the pressure by a rotary pump, to prepare specimens of the poly-(α-hydroxy acid) compositions (Examples 1 to 15). Similarly, the polymer solution not containing any amino acid was cast, to prepare a specimen (Comparative Example 1). Each of the specimens was sandwiched between 18 mm square cover glasses, and crystallization rate was measured by use of a crystallization rate measuring device MK-701 (produced by Kotaki Shoji K K). The temperature conditions were a resin melting temperature of 150° C. and a crystallization temperature of 45° C. for poly(p-dioxanone), and a resin melting temperature of 190° C. and a crystallization temperature of 100° C. for poly-L-lactic acid. The crystallization rate was expressed in terms of the time (=half crystallization time) necessary for exhibiting a depolarization strength equal to one half of the depolarization strength exhibited in the sufficiently crystallized state. The results are shown in Table 2 below.

TABLE 2

| Kind of | | A | | B | | C |
|---|---|---|---|---|---|---|
| Amino Acid | | (min) | | (min) | | (min) |
| L-p-tyrosine | Ex. 1 | 0.5 | Ex. 8 | 0.3 | Ex. 9 | 7.3 |
| L-leucine | Ex. 2 | 1.4 | — | — | Ex. 10 | 5.1 |
| Glycine | Ex. 3 | 0.7 | — | — | Ex. 11 | 21.6 |
| L-serine | Ex. 4 | 2.2 | — | — | Ex. 12 | 33 |
| L-asparagine | Ex. 5 | 2.2 | — | — | Ex. 13 | 60 |
| L-phenylalanine | Ex. 6 | 0.6 | — | — | Ex. 14 | 30 |
| L-proline | Ex. 7 | 3.4 | — | — | Ex. 15 | 19.4 |
| Not added | Comp. | 4.6 | — | — | Comp. | 80 |
| | Ex. 1 | | | | Ex. 2 | |

A: Half crystallization time of poly(p-dioxanone) admixed with coloring matter
B: Half crystallization time of poly(p-dioxanone) not admixed with any coloring matter
C: Half crystallization time of poly L-lactic acid not admixed with any coloring matter

It was found that the poly-(α-hydroxy acid) compositions according to the present invention prepared in Examples 1 to 15 which are admixed respectively with various amino acids are much shorter in half crystallization time, i.e. are solidified more easily after cooling, than the polymers prepared in Comparative Examples 1 and 2 which are not admixed with any amino acid. In addition, it was found from the results of Examples 1 and 8 that the presence or absence of a coloring matter does not influence the crystallization rate.

### Example 16

### <Dependence on Amino Acid Concentration>

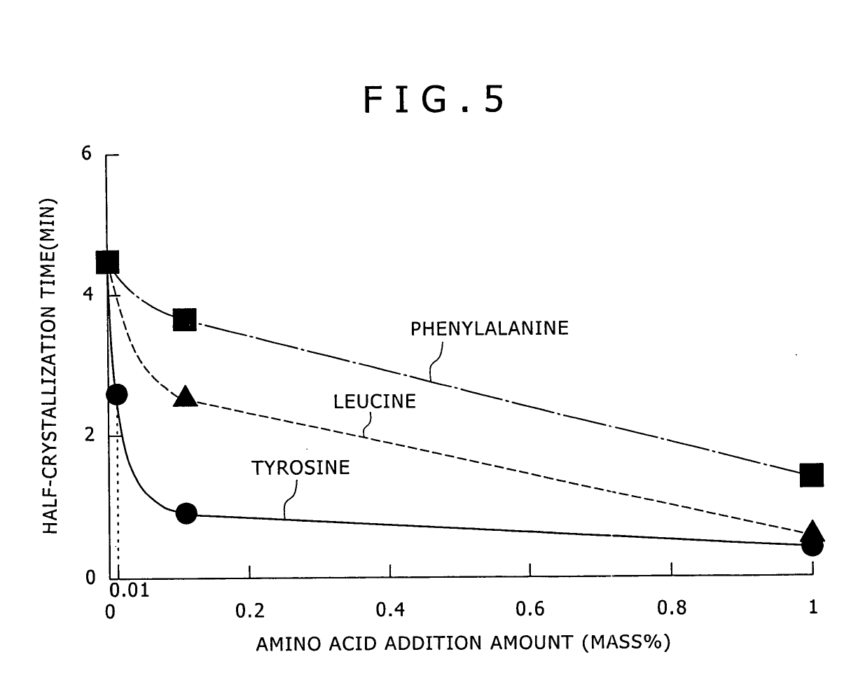

Specimens were prepared in the same manner as in the <Influence of Amino Acid Addition on Crystallization Rate> above, after addition of L-p-tyrosine, L-leucine and L-phenylalanine fine powders prepared in Preparation Examples 1, 2 and 6 respectively to hexafluoroisopropanol solutions (concentration: 5 g/dL) of crushed pellets (inherent viscosity: 2.3 dL/g) of poly(p-dioxanone) containing 1,000 ppm of D&C Violet No. 2 as a coloring matter, with the content of the amino acid fine powder based on the mass of the polymer being varied. The half crystallization time was measured by the same method as in the <Influence of Amino Acid Addition on Crystallization Rate>, and the half crystallization time was plotted against the concentration of the amino acid. The results are shown in FIG. 5.

As seen from FIG. 5, it was found out that L-p-tyrosine, L-leucine and L-phenylalanine, when being in a content of not less than 0.01% by weight, enhance the crystallization rate of the poly-(α-hydroxy acid) composition, and that this effect is conspicuous particularly when L-p-tyrosine is added.

### Example 17

The moldability of an poly-(α-hydroxy acid) composition which contains L-p-tyrosine was evaluated by the method as follows.

### <Preparation of Poly-(α-hydroxy Acid) Composition for Molding>

A pulverized product (inherent viscosity: 2.2 to 2.4 dL/g) of poly(p-dioxanone) containing 1,000 ppm of D&C Violet No. 2 as a coloring matter and 0.2 g of an L-p-tyrosine fine powder prepared in Preparation Example 1 were dry blended, and the blend was melt kneaded at 120° C. for about 20 min by use of a Banbury mixer (a system including a Banbury mixer B250 mounted to a Labo-Plasto Mill 75C100, produced by Toyo Seiki Seisaku-Sho, Ltd.). The resin recovered was pressed at 120° C. to form it into the shape of a sheet having a thickness of about 0.5 mm, the sheet was cut to a size of 2 mm×6 mm, and the strip was dried not less than overnight in an oven at 80° C., to obtain an poly-(α-hydroxy acid) composition for molding. The poly-(α-hydroxy acid) composition for molding had a viscosity in the range of 2.1 to 2.4 dL/g, and showed a half crystallization time of 0.4 minute, as measured by the same method as in the

### <Influence of Amino Acid Addition on Crystallization Rate>Above.

### <Injection Molding>

The poly-(α-hydroxy acid) composition for molding prepared as above was molded by use of a 20 t injection molding machine (produced by Nissei Plastic Industrial Co., Ltd.; screw diameter: 19 mm; maximum injection capacity: 18 mL/shot; maximum injection pressure 1990 kg/cm²; maximum injection velocity: 36 cm²/sec; maximum mold clamping force: 20 t). The molded article had a pantograph shape as shown in FIG. 3, and this molded article for evaluation had a volume of 0.05 mL. The injection conditions in the molding machine were a cylinder temperature of 120° C. or 140° C. and a mold temperature of 45° C., and the cooling time suitable for stable removal of the molded article with the desired shape was determined.

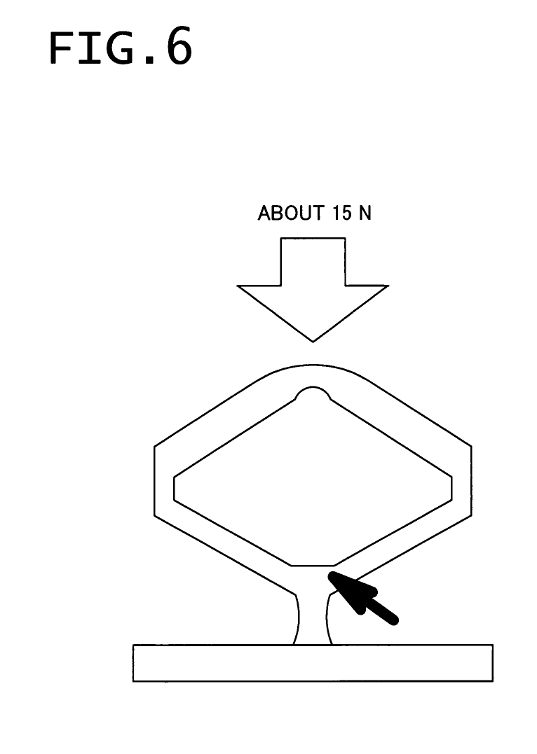

In addition, the molded article for evaluation shown in FIG. 6 was deformed by applying a force of about 15 N to the molded article from the upper side, and the portion indicated by the bold arrow in FIG. 6 was observed from above. The molded articles having a crack or a groove upon observation were taken as defective, and the percent of the defective molded articles was obtained, as percent defective. The results are shown in FIG. 3 below.

### Comparative Example 3

Preparation and injection molding of a poly-(α-hydroxy acid) composition for molding were carried out in the same manner as in Example 17, except for omitting the addition of L-p-tyrosine. The results are shown in Table 3 below.

TABLE 3

| | 120° C. | | | 140° C. | | |
|---|---|---|---|---|---|---|
| | | Percent | | | Percent | |
| | Cooling | defec- | | Cooling | defec- | |
| Cylinder | time | tive | Number | time | tive | |
| temperature | (sec) | (%) | n | (sec) | (%) | Number n |
| Example 17 | 8 to 30 | 2 | 40 | 15 to 40 | 0 | 40 |
| Comp. Ex. 3 | 40 | 14 | 39 | 150 | 50 | 19 |

As is clear from Table 3, the cooling time of the molded article molded from the poly-(α-hydroxy acid) composition according to the present invention with L-p-tyrosine added thereto was shortened, as compared with the molded article in Comparative Example without addition of L-p-tyrosine. In addition, the percent defective (upon molding) in Example 17 corresponding to the poly-(α-hydroxy acid) according to the present invention is also improved, as compared with that in Comparative Example 3. Furthermore, though not shown in Table 3, molding of the poly-(α-hydroxy acid) composition of Example 17 at a cylinder temperature of 160° C. was also investigated, where the cooling time was found to be 40 seconds. It was thus found that the cooling time can be shortened as compared with the related art, also at a cylinder temperature of 160° C.

The present invention is not limited to the details of the above described preferred embodiments. The scope of the invention is defined by the appended claims and all changes and modifications that fall within the equivalence of the scope of the claims are therefore to be embraced by the invention.

What is claimed is:

1. A poly-(α-hydroxy acid) composition comprising:
a poly-(α-hydroxy acid); and
an amino acid.

2. The poly-(α-hydroxy acid) composition according to claim 1, wherein the content of the amino acid is 0.01 to 10% by weight of the poly-(α-hydroxy acid) composition.

3. The poly-(α-hydroxy acid) composition according to claim 1, wherein the amino acid is tyrosine.

4. The poly-(α-hydroxy acid) composition according to claim 3, wherein the tyrosine is p-tyrosine.

5. The poly-(α-hydroxy acid) composition according to claim 3, wherein the content of the tyrosine is 0.01 to 2% by weight of the poly-(α-hydroxy acid) composition.

6. The poly-(α-hydroxy acid) composition according to claim 1, wherein the poly-(α-hydroxy acid) is poly(p-dioxanone).

7. The poly-(α-hydroxy acid) composition according to claim 1, wherein the poly-(α-hydroxy acid) is polylactic acid.

8. An in vivo embedded device formed from the poly-(α-hydroxy acid) composition according to claim 1.

9. A method of producing a molded article, comprising steps of:
mixing a poly-(α-hydroxy acid) with an amino acid to prepare a poly-(α-hydroxy acid) composition; and
molding the poly-(α-hydroxy acid) composition.

10. The method of producing a molded article according to claim 9, wherein the step of preparing the poly-(α-hydroxy acid) composition comprises melting and kneading the poly-(α-hydroxy acid) with the amino acid.

11. The method of producing a molded article according to claim 9, wherein the step of molding the poly-(α-hydroxy acid) composition comprises performing injection molding at an injection molding machine cylinder temperature of 120 to 140° C., an injection molding machine mold temperature of 40 to 50° C., and a cooling time in the mold of the injection molding machine of 5 to 40 seconds.

12. A molded article formed from the poly-(α-hydroxy acid) composition according to claim 1.

13. The molded article according to claim 12, wherein the content of the amino acid in the poly-(α-hydroxy acid) composition is 0.01 to 10% by weight of the poly-(α-hydroxy acid) composition.

14. The molded article according to claim 12, wherein the amino acid is tyrosine.

15. The molded article according to claim 14, wherein the tyrosine is p-tyrosine.

16. The molded article according to claim 14, wherein the content of the tyrosine is 0.01 to 2% by weight of the poly-(α-hydroxy acid) composition.

17. The molded article according to claim 12, wherein the poly-(α-hydroxy acid) is poly(p-dioxanone).

18. The molded article according to claim 12, wherein the poly-(α-hydroxy acid) is polylactic acid.

19. A blood vessel wall closing device comprising the molded article according to claim 12.
